(19) United States
(12) Patent Application Publication
(10) Pub. No.: US 2005/0244804 A1
(43) Pub. Date: Nov. 3, 2005

(54) Process of relaying a story having a unique plot

(76) Inventor: Andrew F. Knight, Vienna, VA (US)

Correspondence Address: ANDREW F. KNIGHT, 2770 AIRLINE GOLDMINE RD., CANON, GA, 30520, US

(21) Appl. No.: 10/722,473

(22) Filed: Nov. 28, 2003

(51) Int. Cl. G09B 25/00

(52) U.S. Cl. 434/365

(57) ABSTRACT

A process of relaying a story having a timeline and a unique plot involving characters comprises: indicating a character's desire at a first time in the timeline for at least one of the following: a) to remain asleep or unconscious until a particular event occurs; and b) to forget or be substantially unable to recall substantially all events during the time period from the first time until a particular event occurs; indicating the character's substantial inability at a time after the occurrence of the particular event to recall substantially all events during the time period from the first time to the occurrence of the particular event; and indicating that during the time period the character was an active participant in a plurality of events.

### BACKGROUND

Hollywood has been failing. Hackneyed plots are commonplace in modern movies and creativity has been replaced by expensive “special effects.” Elaborate explosions and sophisticated fight scenes bore even the slightest intellect where the storyline is confused, dull, or lacking. There is a substantial need for original, intellectually exciting plots in all forms of entertainment, such as novels and, particularly, motion pictures.

Traditionally, patent protection has provided the economic and moral impetus for technological improvements in all fields. An inventor is motivated to absorb the substantial financial, time, and personal costs of identifying problems with current technologies and inventing solutions to those problems when he is assured the right to exploit that invention by excluding others from making, using, selling, offering to sell, and importing his invention. 35 U.S.C. §271. Where patent protection is not available or is not easily obtained or enforced, such as in the typically statist welfare countries of Central and South America and communist countries such as China, technological progress is stunted by at least two causes: a) inventors employed by a company little motivation to disclose their inventions to the public, and thus tend to keep their inventions as trade secrets within the company; and b) independent inventors have virtually no motivation whatsoever to disclose their inventions to anyone, because of (justifiable) fears of appropriation.

In much the same way, the progress of intelligent fictional plots, particularly of movies, has been stunted worldwide. Currently, a writer may receive free, comprehensive, and automatic copyright protection on anything she writes. If her skill consists primarily of expressing old, stale concepts in new, creative, exciting ways, then she will benefit from copyright protection. However, if her skill consists primarily of inventing new and unique broad concepts, then copyright protection will only protect one of uncountably many possible expressions of those new and unique concepts. This dangerous dichotomy is explained further.

Patents and copyrights aim to protect different interests. A copyrighted work is a particular expression or embodiment of a broader concept. For example, a broad concept might be, “Life is worth living for its own sake, and the only economic system that respects humans' right to live freely for their own happiness, without brute force compulsion to be sacrificed for the benefit of others, is capitalism.” A particularly beautiful expression of this broad concept is Ayn Rand's Atlas Shrugged, which is subject to copyright protection. Ayn Rand's estate does not own all embodiments of the broad concept—only the single expression embodied by her novel.

In sharp contrast, a patented invention protects each and every possible embodiment of a broad invention. Consider a patent on a car. It is not a particular actual car that is the subject of a patent, rather the wide class of possible cars that fall within the scope of the patent. In other words, a particular car is simply one protected embodiment of the broader patented invention. Because of the broad scope of rights afforded to a patent owner, one may not receive a patent on an invention that is old or obvious. 35 U.S.C. §§102-103.

Thus, patent protection and copyright protection differ substantially on the ease with which infringement may be avoided. Because a patent protects all expressions or embodiments of the single broad invention, a competitor who desires to use or sell the invention without paying royalties may not; it may only avoid patent infringement by paying royalties or avoiding the invention altogether. In sharp contrast, a competitor who desires to use the broad concept disclosed in another's work (e.g., book or article) may freely do so without infringing any copyrights, even when the broad concept is new and nonobvious. All the competitor must do is to create a moderately different expression of the broad concept.

It is clear that copyrights protect those who are good performers: those who sing well, dance well, write well, act well, and so forth. Copyrights are based on a system of recognition in which society rewards performers because they express an old concept in an original (and hopefully desirable) way, not because they express a new concept. Of course, many artists do invent original concepts, but it is their expression of those concepts, not their creation or invention of those concepts, that copyright protection rewards.

For example, one who sings a touching version of “White Christmas” may receive copyright protection on his performance—not because he invented the concept of singing about Christmas—not because he wrote the lyrics to the song—but because his particular vocal expression of it is original. Further, a woman who writes and performs a love song may receive copyright protection on both the lyrics and her performance—not because she invented the concept of singing about love—but because her particular written expression of love, and her particular vocal expression of those written lyrics, are original. Finally, consider the man who invents an entirely new and nonobvious type of music or method of performing music. Clearly, copyright law cannot protect his invention. His only possible resource—which, to date, has not been tapped for the field of artistic inventions, such as original movie plots and new types of artistic expression—is patent protection.

There is no reason—neither statute nor case law nor PTO practice—why artistic inventions are not patentable subject matter under 35 U.S.C. §101. In the landmark decision Diamond v. Chakrabarty (447 U.S. 303, 1980), the Supreme Court held that living creatures were patentable subject matter under the doctrine that statutory subject matter includes “anything under the sun that is made by man,” with three exceptions: laws of nature, physical phenomena, and abstract ideas. According to the Manual of Patent Examining Procedure, these three exceptions recognize that subject matter that is not a practical application or use of an idea, a law of nature, or a natural phenomenon is not patentable. §2106 (IV)(A).

Certainly a movie implementing a unique plot is a practical application or use of the unique plot, so the unique plot should not be barred patentability under §101. The invention of a new plot is just that—an invention—not merely an expression of an existing concept. Similarly, the practical application or use of any new artistic invention should be patentable subject matter.

The fact that each particular expression (e.g., a movie) of a broad artistic invention (e.g., an original plot) is subject to copyright protection is not unique to artistic inventions. For example, the software code on a patented software-containing disk may be copyrighted. The defining criterion separating the subject matter of patents from copyrights is not whether the subject matter is related to art—see the amusing counterexample of U.S. Pat. No. 6,213,778 to Cohen. Rather, the defining criterion is whether the subject matter is a broad concept practically applied or used (patent), or a particular instance, embodiment, expression, or performance of the broad concept (copyright).

There is little fear that artistic creation will be halted due to the enforcement of patent protection newly applied to artistic inventions. A love song composer may indefinitely continue writing love songs without worry of infringing any patent, because the concept of writing songs about love is old and not patentable. Statute clearly requires an invention to be new and nonobvious to receive patent coverage. Thus, even if the broad concept or invention of singing about love were statutory subject matter under §101, it is as old as civilization, and would not survive an attack under §§102-103. In fact, most artistic concepts today are very old—which is precisely the problem that must be remedied by patent protection for artistic inventions. Unless patents on artistic inventions are upheld and enforceable, the great artistic minds of the day will be compelled to continue composing predictable love songs for pop stars and slightly altered dialogues for carbon copied movie plots.

There is currently little motivation for artistic inventors to innovate new plots, themes, and methods of expression. The value of an innovator's copyright, if he in fact embodies his invention in a particular expression (such as a novel or movie) is far less than the value of the invention itself, because the invention umbrellas every possible embodiment. Further, and perhaps more importantly, the value of his copyright depends on his ability as a performer, not as an inventor. An artistic inventor who invents a fantastically original and compelling plot may not be a particularly skilled writer. He may, for example, have a very limited vocabulary and a poor understanding of grammar. Any book he creates will be avoided by any potential buyer who reads the first paragraph, such that the copyright value of his extremely valuable invention is nil. Any Hollywood producer who sees through the book's garbled sentence structure to the excellent and creative plot beneath the surface may steal the only value the book contained: its inventive plot. The producer may then moderately alter the expression of the plot in a subsequent movie—while keeping the plot's essence fully intact—and obtain unearned financial benefit from the inventor's unrewarded hard work and innovation. If there is any evil that the United States patent system ought to prevent, it is this.

Said another way: the value of a singer's performance or a dancer's performance or a writer's performance or an artist's performance is in the performance, while the value of an inventor's invention is in the invention, not a single instance, embodiment, expression, or performance of the invention. The value of a performance is protected by copyright; the value of an invention is not. An artistic innovator is given but two choices absent patent protection: to sacrificially innovate for the unearned benefit of thieves, or to not innovate. Both options are morally and practically repulsive.

A patent system that sanctions and defends patents on artistic inventions, such as new and nonobvious plots, will spur an array of never-seen-before, never-experienced-before, intellectually inspiring forms of entertainment. A patent system that lethargically clings to an as-of-yet unarticulated rule that artistic inventions are not patentable subject matter because they are not closely enough related to a mechanical gear or an electronic integrated circuit will guarantee our nation the same repertoire of mind numbing movies and dime-a-dozen boy bands.

### SUMMARY OF THE INVENTION

The present invention aims to solve at least one of these and other problems discussed.

In a preferred embodiment of the present invention, a process of relaying a story having a timeline and a unique plot involving characters may comprise: indicating a character's desire at a first time in the timeline for at least one of the following: a) to remain asleep or unconscious until a particular event occurs; and b) to forget or be substantially unable to recall substantially all events during the time period from the first time until a particular event occurs; indicating the character's substantial inability at a time after the occurrence of the particular event to recall substantially all events during the time period from the first time to the occurrence of the particular event; and indicating that during the time period the character was an active participant in a plurality of events. Each of the steps may comprise indicating in a written form or a video form. The process may further comprise indicating that the particular event has occurred at a second time in the timeline at least one week after the first time; and indicating the character's substantial inability at a time after the second time to recall substantially all events during the time period from the first time to the second time. The second time may be at least a month, a few months, a year, a few years, five years, ten years, twenty years, or more after the first time.

In a preferred aspect, the particular event may be at least one of: a passing of a particular amount of time; a notification of a decision; and a relief of a pain. In another aspect, the plurality of events may comprise at least one of the character's wedding, a birth of a child of the character, and performance of the character's occupation for a substantial portion of the time period. In another aspect, the process may further comprise indicating a belief held by at least three other characters that the character was conscious during the active participation in the plurality of events.

In another preferred aspect, the process may be a process of displaying a motion picture having a timeline and a unique plot, comprising: displaying a video representation of an actor acting as the character; displaying a video representation of the actor indicating at the first time in the timeline a desire for the at least one of a) and b); displaying a video representation of an indication that the particular event has occurred at a second time in the timeline; displaying a video representation of the actor indicating at a time after the second time a substantial inability to recall substantially all events during the time period from the first time to the second time; and displaying a video representation of an indication that during the time period the character was an active participant in a plurality of events.

In another preferred aspect, the process may be a process of creating a motion picture having a timeline and a unique plot, comprising: creating a video representation of an actor acting as the character; creating a video representation of the actor indicating at the first time in the timeline a desire for the at least one of a) and b); creating a video representation of an indication that the particular event has occurred at a second time in the timeline; creating a video representation of the actor indicating at a time after the second time a substantial inability to recall substantially all events during the time period from the first time to the second time; and creating a video representation of an indication that during the time period the character was an active participant in a plurality of events.

In another preferred aspect, the process may be a process of creating a motion picture having a timeline and a unique plot, comprising: providing a set; providing a video camera configured to video at least a portion of the set; inciting an actor to act as the character; inciting the actor to indicate at the first time in the timeline a desire for the at least one of a) and b); creating a first video segment via the video camera by filming the indication by the actor at the first time; inciting the actor to indicate at a time after the occurrence of the particular event a substantial inability to recall substantially all events during the time period from the first time to the occurrence of the particular event; creating a second video segment via a video camera by filming the indication by the actor at the time after the occurrence of the particular event; creating a third video segment of an indication that during the time period the character was an active participant in a plurality of events; editing and combining at least part of at least the first, second, and third video segments to form a motion picture; and storing the motion picture on an information storage medium.

In another preferred aspect, the process may be a process of creating a motion picture having a timeline and a unique plot, comprising: inciting an actor to act as the character; inciting the actor to indicate at the first time in the timeline a desire for the at least one of a) and b); indicating that the particular event has occurred at a second time in the timeline; and inciting the actor to indicate at a time after the second time a substantial inability to recall substantially all events during the time period from the first time to the second time.

In another preferred aspect, the process may further comprise inciting the actor to indicate a belief that the particular event will occur at an approximate time in the timeline that is substantially earlier than the second time. In another preferred aspect, the process may further comprise inciting a second actor to indicate a belief that the character was conscious during the active participation in the plurality of events. In another preferred aspect, the process may further comprise: indicating that the plurality of events are stored in the character's brain; and inciting a third actor to indicate an ability to recreate at least some of the plurality of events by accessing the character's brain, wherein the plurality of events comprises at least one of the character's wedding, a birth of a child of the character, and performance of the character's occupation for a substantial portion of the time period, and wherein the second time is at least one year after the first time.

In another preferred aspect, the process may further comprise: indicating that the plurality of events are stored in the character's brain; and indicating a second character's ability to recreate at least some of the plurality of events by accessing the character's brain.

In another preferred embodiment of the present invention, an information storage medium may contain information of a story having a timeline and a unique plot involving characters, the information comprising: an indication of a character's desire at a first time in the timeline for at least one of the following: a) to remain asleep or unconscious until a particular event occurs; and b) to forget or be substantially unable to recall substantially all events during the time period from the first time until a particular event occurs; an indication that the particular event has occurred at a second time in the timeline; an indication of the character's substantial inability at a time after the second time to recall substantially all events during the time period from the first time to the second time; and an indication that during the time period the character was an active participant in a plurality of events. The information storage medium may be a book.

In a preferred aspect, the information storage medium contains video information of a motion picture, the video information comprising: a video representation of an actor acting as a character; a video representation of the actor indicating at a first time in the timeline a desire for at least one of the following: a) to remain asleep or unconscious until a particular event occurs; and b) to forget or be substantially unable to recall substantially all events during the time period from the first time until a particular event occurs; a video representation of an indication that the particular event has occurred at a second time in the timeline; a video representation of the actor indicating at a time after the second time a substantial inability to recall substantially all events during the time period from the first time to the second time; and a video representation of an indication that during the time period the character was an active participant in a plurality of events. The information storage medium may be a DVD or VCD disk or VHS tape.

### DETAILED DESCRIPTION OF PREFERRED EMBODIMENTS

A theme of the plot (e.g., for a movie or novel) of the present invention is the nature of consciousness, the difference between outward appearance and introspective self-consciousness, and the importance of active decisionmaking in the day-to-day formation of conscious experiences. Life is about experiences: not just any experiences, but those that are consciously experienced. An event has no meaning or value as an experience where it is immediately and permanently forgotten, as if the active participant in the event were asleep during the event.

A preferred embodiment of the present plot invention will now be described. The setting is preferably some time between the present and fifty years ago, although preferably about 20 to 40 years ago, in a suburban section of the United States. Of course, these details, as well as any other detail described herein, may be altered without deviating from the scope of the present invention. The protagonist or main character is a man who, in the initial setting, is a teenage boy. He is very motivated and a diligent student, and has dreamed for many years of attending college at one particularly well-known and prestigious school, such as the Massachusetts Institute of Technology (MIT). His father is a successful lawyer who wishes him to also pursue law, but the boy observes his father's unending work schedule and high stress level, and determines to seek a different, more exciting, more rewarding path in life. During his junior or senior year of high school, he applies to MIT. He expresses to his girlfriend his explosive desire to be accepted; a few weeks before the expected arrival of his admissions decision letter, he tells her how he simply can't wait any longer, that his anticipation has consumed his every thought. That night, he convinces himself that he wants to leap over the time until the admissions letter arrives—that he doesn't want to experience anything else until it arrives—that he just wants to go to sleep and not wake up until it does. He falls asleep.

Next (such as in the next scene in the movie), a mail carrier knocks on a door on a house in an upper-class neighborhood. The setting is preferably now, or about 20 to 40 years after the initial setting. The man who answers the door is middle-aged. The mail carrier hands him a letter, saying something to the effect of, “Sincere apologies, sir. It looks like we've had this letter in our possession for a few decades . . . it dropped underneath a table and we didn't find it until yesterday.” The letter has a return address of MIT's Admissions Committee, and is clearly the letter that the protagonist had been awaiting at the time he wished himself unconscious. Suddenly, it is made clear, via the art of cinematography, that the man at the door is the protagonist, that he recognizes what the letter is, and that he is consciously “waking up.” For example, the movie may zoom in on the man's eyes as a look of wonder, newly awakened intelligence, and confusion crosses them. In other words, he is not physically waking up from slumber. Rather, he is waking up consciously, as if his last conscious memory or experience was when he wished to remain unconscious (until the arrival of MIT's decision letter) and lied down—several decades ago.

The protagonist looks around the room in which he stands, bewildered and frightened. He sees photographs of children and relatives. He sees himself and his high school girlfriend in a wedding photograph. He sees a framed newspaper article cutout entitled, “Local Man Wins Landmark Lawsuit,” including a photograph of what appears to be an older, grayed version of himself. Then, he spots a mirror on the wall and looks at himself in it. Slowly, a crystal clear realization envelopes him that so many decades have passed, that he has no recollection of the passed time, and that his last memory was of being a young teenager. He realizes bitterly and resentfully that his wish was granted.

The next scenes may further elaborate on this event as the movie illustrates what a typical man might do or how he might act in such a situation. For example, he may go a little crazy, running from his family and job, as he doesn't recognize either one as his. He identifies as the teenage boy who has no obligations, no children, no job, no wife, and no memory of the past few decades, and so goes on a search for the truth. What happened? he asks. How can I fix it? he wonders. He may have a confrontation with his wife or children, who recognize him as their husband and father, and have no idea why he is acting so strangely.

Eventually, whether by help from his wife or through a referral, he seeks psychological help. The first psychologist may not be particularly helpful, but refers him to a more animated, less known, brilliant psychologist, who may play an important role in the plot, such as one of problem solver, confidant, and erudite philosopher. The psychologist explains what has happened: consciousness and brain activity are distinct entities—the first may be turned off while the second remains on. He explains the logistics of consciousness: consciousness and memory formation are interdependent. When one cannot recall the events of a particular just-preceding time period—i.e., when one's most recent memory was of something long ago—then that person was not conscious during that time period. When one's consciousness is switched off from time A to B, one's experience seems to skip over the time from A to B, as if time were continuous but simply did not include the time from A to B. The person experiences a perceived continuity as if time B was immediately subsequent to time A. The result: one may perceive only a minute where a few decades have passed.

The psychologist further explains a minority held and understood opinion that humans are capable of consciously turning off their consciousness, whether or not a condition in placed on the re-ignition of the consciousness. For example, a person may consciously wish to stop living or to stop thinking, and the brain will turn off the person's consciousness indefinitely. Or, a person may consciously wish to stop being conscious until a particular point in time or an event, such as the receipt of an important notification or the relief of some physical or emotional pain, in which case the brain will diligently turn off the person's consciousness and re-ignite the consciousness at the occurrence of the particular event. The result in either case is the creation of a zombie. A zombie is a person who looks conscious, acts conscious, says things that a conscious person might say (to be contrasted with the haphazard babbling of a sleep talker), performs in society as a conscious person might perform, etc., but isn't really conscious.

The psychologist looks out the window at a busting crowd of professionals walking past. He asks aloud how many of them are conscious—and how many of them compromised their consciousness for a dream that they never realized. He points to a woman, asking if she had wished to remain unconscious until getting a particular job, and never got it. He points to a man, asking if he had wished to remain unconscious until marrying a particular woman, and never could. He points to another woman, asking if she had wished to remain unconscious until becoming a famous artist, and never did. Then he points to their eyes, and asks if they have the keen, sharp observance of a conscious attention, or the dull, glossy haze of a zombie stare. How many people are not really alive?—who appear to live, love, and learn, but don't?—who have active bodies but inactive souls? he asks.

Then, the psychologist mentions that he has heard of a scientist who may be able to help. The scientist claims that he can recreate the memories of anyone with amnesia or a problem like the protagonist's (i.e., a situation in which a person desired to remain unconscious until a particular event, which ultimately occurs much later in time). The protagonist seeks his help, and the scientist explains that all of the protagonist's memories are stored in his brain, in the form of a particular and reversible configuration (i.e., on-ness or off-ness) of each of the neurons in his brain. By analyzing this configuration, and knowing the nature and magnitude of each of the forces acting on each of the particles (e.g., elementary particles such as electrons) flowing within his brain, the scientist can reversely simulate the motion of the particles and the firing of neurons in his brain, to recreate the configuration of the protagonist's brain when he was a teenager. Then, by storing this information in a database and interpreting this information in the form of visual, auditory, olfactory, tactile, and taste sensations, the scientist can then “play” the protagonist's life to him in the form of a virtual reality movie. In other words, the scientist claims that he can recreate the events during the unconscious years of the protagonist's life, and let the protagonist relive (or, more accurately, consciously live for the first time) these experiences, by accessing the protagonist's brain, obtaining or “downloading” experiential information, interpreting this information, and playing all or parts of this information to the protagonist via a virtual reality setup which may include a head-mounted display, earphones, and a generator of taste, smell, and touch sensations. In one embodiment, the scientist claims that the protagonist may “fast forward” through the dull parts of this unconscious portion of his life and, thus, experience only those more interesting portions. In another embodiment, this feature is not possible, so that it would take the protagonist 30 years to play or “relive” the 30 years of his unconscious life.

Next in the plot, at some point before agreeing to this procedure, the protagonist discovers that the scientist is lying. He discovers that the scientist cannot actually cause a patient to relive his experiences after downloading these experiences from the patient's brain. For example, it may be that downloading the information of these experiences causes such damage to the patient's brain that the patient then goes into a vegetative state or dies. But, because each of the scientist's duped patients remains in a (possibly fake) virtual reality machine for long, long periods of time (e.g., 30 years), none of the patients' loved ones know or learn that the patients have actually been brain damaged or killed. Further, the protagonist discovers that the scientist's motivation for downloading these experiences is to subsequently play the best of these experiences to customers, via a virtual reality machine, for profit. For example, a video editor employed by the scientist may, after downloading and interpreting the experiential information, fast forward through the experiences and selectively choose particularly good (i.e., marketable) experiences, such as the experience of winning a game or award, experiencing a famous or historical event in person, enjoying a good meal in a famous restaurant, meeting or conversing with a famous person, having sex, etc. The editor then clips and labels these experience segments for purchase by people who want to enjoy these experiences in a virtual reality setting, experienced in the same way the original patient experienced them.

There are a wide variety of possible ways that the protagonist could make this discovery, as would be apparent to one of ordinary skill in the art. For example, he could open one of the fake virtual reality machines, only to discover a person in a vegetative state, fed with IV tubes. After the protagonist makes this realization, the scientist may discover that the protagonist knows the truth, and may want to destroy the protagonist for fear of exposure of the truth. Then, a typical Hollywood chase scene may ensue, with the protagonist defending his life and attempting to expose the truth, and the scientist trying to kill him. Eventually, the protagonist destroys the scientist.

There are several possible ways the plot could end. For example, the protagonist could take over the scientist's lab, find the downloaded experiences of another person, and spend the remainder of his days living that alternate life. However, a far better ending is one in which the protagonist has learned a profound lesson in life: the value of conscious experiences. He goes home to his wife and children, and attempts to get to know them. He may quit his hated job as a lawyer and even go back to MIT to begin pursuing what he had always wanted: a meaningful, unique life consistent with his dreams. In other words, he may begin his life again as though he were only a teenager.

A theme that may run through the movie is that, while one must have dreams and goals to motivate one to succeed, the accomplishment of most goals relies at least to some degree on chance. Bad luck can thwart even the best-laid plans. Thus, those who “put all their eggs in one basket,” those whose happiness rests solely on the occurrence of one particular event, are likely to lead a life of failure and dissatisfaction. Success is not merely about achieving a goal, but about having a wide range of easily achievable as well as very challenging goals, and being satisfied with the successes in spite of occasional failures. The good life is about experiences, not a single point in time or a single goal.

What has been described is a preferred embodiment of the plot according to the present invention. Many variations are possible while remaining within the scope of the present invention.

For example, the event that causes the protagonist to consciously wake up may occur only a week, a month, a year, or five years after the original wish was made and the protagonist fell asleep. Also, the protagonist may become unconscious right after making the wish, and may not need to go to sleep before this happens. Also, his becoming unconscious may be a gradual process over the course of a few days. Further, the plurality of events that occur during the protagonist's period of unconsciousness may include any event that is typically associated with consciousness. For example, while a person may walk while asleep (i.e., while unconscious), a person would typically not run a Marathon race while asleep. While a person may talk while asleep, a person would typically not make a televised speech while asleep. For example, the plurality of events could include getting married, having children, getting and performing a job, attending and taking notes in class, playing a sport, writing a piece such as a book or poem, playing a game, having an intelligent conversation, etc. The movie may indicate that the protagonist was an active participant in these plurality events in several ways, as understood by one of ordinary skill in the art: by flashbacks (such as of the protagonist's wife), showing pictures or “family movies” of these events in which it appears that the protagonist was an active participant, in conversation by other characters who remember the events and the protagonist's participation, etc.

Further, the protagonist may indicate a belief that the particular event (whose occurrence he desires to remain unconscious until) will happen much sooner than it actually happens. For example, as in the above plot, the dialogue, series of events, etc., in the movie may clearly indicate that the protagonist believed that his MIT decision letter would arrive within the month—while, in fact, it arrived several decades later. Further, preferably, one or more characters (such as the protagonist's wife and two children) should indicate a belief that the protagonist had been conscious during those decades of unconsciousness. In other words, the plurality of events in which the protagonist had been an active participant indicated to all onlookers that he was fully conscious. The characters may indicate this belief by acting very surprised when they discover that the protagonist does not recall those events, etc.

Further, the particular event may be passing of a particular amount of time. For example, the protagonist may simply express a desire to remain asleep “until next year” or “until this semester is over.” The particular event, as discussed, may be a notification of a decision, such as a jury verdict, an admissions decision, an acceptance decision for a contract or for membership into a prestigious organization or receipt of a prestigious award. Or, the particular event may be relief of a pain, such as a physical pain (“until my leg heals” or “until my disease is cured”) or an emotional pain (“until I have gotten over the passing of my wife”) or a mental pain (“until I have taken the SAT”). The particular event could be any event for which the protagonist is motivated to lose at least a portion of his conscious life.

Further, instead of indicating a desire to remain asleep or unconscious until the particular event occurs, the protagonist may indicate a desire to forget or be unable to recall the events that up until the occurrence of the particular event. For example, he may say something like, “I want to forget everything that happens from now until I receive the MIT admissions letter.”

Clearly, the details may be altered. The setting may be different, the protagonist may be a woman, etc. The protagonist may indicate his desire to remain unconscious until the particular event in several possible ways, such as by stating so, or a loved one (such as his girlfriend) in a different scene may state her knowledge of the protagonist's desire. However, as well known by those of ordinary skill in the art, there are many ways to indicate a fact in a movie without any explicit words to that effect at all: circumstance, cinematography, subtly suggestive newspaper headlines, suggestive words by the protagonist or other characters, etc., can all be indicative of that fact.

The story preferably has a timeline, which will be well understood by one of ordinary skill in the art. For example, in a story containing flashbacks, the timeline may represent the chronological order in which events occur in the story. Therefore, a flashback may occur earlier in the story's timeline, even though the flashback is presented in a later part of the story.

Further, the protagonist may be completely incapable of recalling any event during his period of unconsciousness. Alternatively, he may be able to remember a few events (representing a small fraction of the total), or he may have very fuzzy, vague, or dream-like memories of a few or most events.

The present invention applies to any practical application or use of the present plot. For example, the invention includes the processes of relaying a story having the present plot, writing a book having the present plot, printing a book having the present plot, creating a movie having the present plot, displaying or showing a movie having the present plot, filming a movie having the present plot, inciting actors to act out the present plot, creating an audio recording of a story having the present plot, etc. The present invention also applies to any product of any of these processes—e.g., a book containing written information of a story having the present plot, an audio tape or CD disk containing audio information of a story having the present plot, a VHS tape or DVD or VCD disk containing video information of a movie having the present plot, etc.

For example, creating a movie having the present plot may include inciting an actor to act as the protagonist. As will be understood by one of ordinary skill in the art, a producer or director or production company may incite an actor to act as the protagonist by promising a financial or a career-related reward or advancement. Creating such a movie may also include providing a set, as known by those of ordinary skill in the art, video cameras (preferably high-resolution digital video cameras), and editing equipment, and using the set, cameras, and equipment to create video segments of footage of the actors acting consistent with the present plot. The final video may be stored on an information storage medium, duplicated onto VHS tapes or DVDs, and distributed and sold.

1. A process of relaying a story having a timeline and a unique plot involving characters, comprising:
indicating a character's desire at a first time in said timeline for at least one of the following: a) to remain asleep or unconscious until a particular event occurs; and b) to forget or be substantially unable to recall substantially all events during the time period from said first time until a particular event occurs;
indicating said character's substantial inability at a time after said occurrence of said particular event to recall substantially all events during the time period from said first time to said occurrence of said particular event; and
indicating that during said time period said character was an active participant in a plurality of events.

2. A process of relaying a story as in claim 1, comprising:
indicating that said particular event has occurred at a second time in said timeline at least one week after said first time; and
indicating said character's substantial inability at a time after said second time to recall substantially all events during the time period from said first time to said second time.

3. A process of relaying a story as in claim 2, wherein said second time is at least one year after said first time.

4. A process of relaying a story as in claim 1, wherein said particular event is at least one of: a passing of a particular amount of time; a notification of a decision; and a relief of a pain.

5. A process of relaying a story as in claim 1, wherein said plurality of events comprises at least one of said character's wedding, a birth of a child of said character, and performance of said character's occupation for a substantial portion of said time period.

6. A process of relaying a story as in claim 1, further comprising indicating a belief held by at least three other characters that said character was conscious during said active participation in said plurality of events.

7. A process of relaying a story as in claim 1, wherein each of said steps of indicating comprises indicating in a written form.

8. A process of relaying a story as in claim 1, wherein each of said steps of indicating comprises indicating in a video form.

9. A process of relaying a story as in claim 8, wherein said process is a process of displaying a motion picture having a timeline and a unique plot, comprising:
displaying a video representation of an actor acting as said character;
displaying a video representation of said actor indicating at said first time in said timeline a desire for said at least one of a) and b);
displaying a video representation of an indication that said particular event has occurred at a second time in said timeline;
displaying a video representation of said actor indicating at a time after said second time a substantial inability to recall substantially all events during the time period from said first time to said second time; and
displaying a video representation of an indication that during said time period said character was an active participant in a plurality of events.

10. A process of relaying a story as in claim 8, wherein said process is a process of creating a motion picture having a timeline and a unique plot, comprising:
creating a video representation of an actor acting as said character;
creating a video representation of said actor indicating at said first time in said timeline a desire for said at least one of a) and b);
creating a video representation of an indication that said particular event has occurred at a second time in said timeline;
creating a video representation of said actor indicating at a time after said second time a substantial inability to recall substantially all events during the time period from said first time to said second time; and
creating a video representation of an indication that during said time period said character was an active participant in a plurality of events.

11. A process of relaying a story as in claim 8, wherein said process is a process of creating a motion picture having a timeline and a unique plot, comprising:
providing a set;
providing a video camera configured to video at least a portion of said set;
inciting an actor to act as said character;
inciting said actor to indicate at said first time in said timeline a desire for said at least one of a) and b);
creating a first video segment via said video camera by filming said indication by said actor at said first time;
inciting said actor to indicate at a time after said occurrence of said particular event a substantial inability to recall substantially all events during the time period from said first time to said occurrence of said particular event;
creating a second video segment via a video camera by filming said indication by said actor at said time after said occurrence of said particular event;
creating a third video segment of an indication that during said time period said character was an active participant in a plurality of events;
editing and combining at least part of at least said first, second, and third video segments to form a motion picture; and
storing said motion picture on an information storage medium.

12. A process of relaying a story as in claim 8, wherein said process is a process of creating a motion picture having a timeline and a unique plot, comprising:
inciting an actor to act as said character;
inciting said actor to indicate at said first time in said timeline a desire for said at least one of a) and b);
indicating that said particular event has occurred at a second time in said timeline; and
inciting said actor to indicate at a time after said second time a substantial inability to recall substantially all events during the time period from said first time to said second time.

13. A process of relaying a story as in claim 12, further comprising inciting said actor to indicate a belief that said particular event will occur at an approximate time in said timeline that is substantially earlier than said second time.

14. A process of relaying a story as in claim 12, further comprising inciting a second actor to indicate a belief that said character was conscious during said active participation in said plurality of events.

15. A process of relaying a story as in claim 14, further comprising:
indicating that said plurality of events are stored in said character's brain; and
inciting a third actor to indicate an ability to recreate at least some of said plurality of events by accessing said character's brain,
wherein said plurality of events comprises at least one of said character's wedding, a birth of a child of said character, and performance of said character's occupation for a substantial portion of said time period, and
wherein said second time is at least one year after said first time.

16. A process of relaying a story as in claim 1, further comprising: indicating that said plurality of events are stored in said character's brain; and indicating a second character's ability to recreate at least some of said plurality of events by accessing said character's brain.

17. An information storage medium containing information of a story having a timeline and a unique plot involving characters, said information comprising:
an indication of a character's desire at a first time in said timeline for at least one of the following: a) to remain asleep or unconscious until a particular event occurs; and b) to forget or be substantially unable to recall substantially all events during the time period from said first time until a particular event occurs;
an indication that said particular event has occurred at a second time in said timeline;
an indication of said character's substantial inability at a time after said second time to recall substantially all events during the time period from said first time to said second time; and
an indication that during said time period said character was an active participant in a plurality of events.

18. An information storage medium as in claim 17, wherein said information storage medium is a book.

19. An information storage medium as in claim 17, wherein said medium contains video information of a motion picture, said video information comprising:
a video representation of an actor acting as a character;
a video representation of said actor indicating at a first time in said timeline a desire for at least one of the following: a) to remain asleep or unconscious until a particular event occurs; and b) to forget or be substantially unable to recall substantially all events during the time period from said first time until a particular event occurs;
a video representation of an indication that said particular event has occurred at a second time in said timeline;
a video representation of said actor indicating at a time after said second time a substantial inability to recall substantially all events during the time period from said first time to said second time; and
a video representation of an indication that during said time period said character was an active participant in a plurality of events.

20. An information storage medium as in claim 19, wherein said information storage medium is a DVD.
